(19) United States
(12) Patent Application Publication
(10) Pub. No.: US 2017/0226773 A1
(43) Pub. Date: Aug. 10, 2017

(54) WEATHER RESISTANT PIN LOCK

(71) Applicant: WESKO SYSTEMS LIMITED, Mississauga, CA (US)

(72) Inventors: John McLEOD, Toronto (CA); Tonino SABELLI, Oakville (CA)

(21) Appl. No.: 15/050,709

(22) Filed: Feb. 23, 2016

(30) Foreign Application Priority Data
Feb. 9, 2016 (CA) 2,920,469

(51) Int. Cl. E05B 27/00; E05B 17/00; E05B 15/16; E05B 65/44; E05B 17/14; E05B 17/18

(52) U.S. Cl. CPC E05B 27/0003; E05B 17/142; E05B 17/183; E05B 15/16; E05B 65/44; E05B 17/002

(57) ABSTRACT

A weather resistant pin lock with an elongated body, defining a longitudinal axis includes a shell housing a rotatable core having a keyway. An elevated pinway projects upwardly from the shell to define a linear array of pin slots containing a set of lock pins. A hood is fastened to the pinway to hold the lock pins in the pin slots and to provide a water resistant barrier. A drainway provides a channel for water to flow outwardly from the interior of the shell, the rotatable core and the keyway within the core, to a drain below the pin lock. At the proximate end, an access door rotates adjacent the keyway at an elevated position, to provide a gap along the bottom edge of the access door.

### BACKGROUND

Field

The present invention relates to pin locks and to a method of providing weather resistant features to the pin locks, which are desirable for outdoor use.

Description of the Related Art

Earlier pin locks are prone to weather related failure, corrosion, water penetration and other weather related problems. U.S. patent application Ser. No. 12/004,856 filed on Dec. 21, 2007 and published under publication number 2008/0276666 is an example of one such available pin lock.

See FIGS. 1-3 and 7 of the present application which illustrate the features of one example of a prior art pin lock used in mailboxes including outdoor mailbox applications. When this lock design is installed in locations which are exposed to outdoor weather conditions, there are a number of potential weather related issues.

By way of example, when installed in outdoor locations, such locks are prone to freezing particularly during weather conditions including temperature changes from rain to freezing rain or snow. With regard to the prior art drawings, FIGS. 1-3 and particularly FIG. 1, water ingress is often a problem from:
The front of the prior art pin lock between keyhole 125 and dust cover 119 and between cylinder 101 and plug cap 123; and
The top of the prior art pin lock at the interface between the spring retainer 117 and the surrounding edge of the prior art cylinder 101. Furthermore, the shape of the top rear of cylinder 101 allows water dripping down from the mail compartment door to be biased towards spring retainer 117. The spring retainer 117 is made from flat bar material. Spring retainer 117 is held in place by crimping the surrounding edge of the cylinder 101 to form an overlapping lip from the cast metal used to make the cylinder 101. Often, tolerances are such that water can easily pass around and under the lip and around the edges of spring retainer 117, into the pin chambers below.

The rear of the prior art pin lock may also experience water ingress between cylinder 101 and plug 103. The dust cover 119 frequently does not fully close when dust, dirt or ice is present. The upper and lower pivot points of dust cover 119 are square and do not promote easy or smooth pivoting of the door. Water may pool at the lower pivot point which in turn may freeze and hinder movement of the dust cover.

Under these circumstances, water may freeze and render the lock inoperable. By way of further example:
Pins 113, retainer 126 and springs 115 may freeze in the pin chambers thus preventing the key from turning;
Ice may build up in cylinder 101 to prevent plug 103 from rotating. With regard to FIG. 2, stop 601 may prevent cylinder 101 from rotating if ice builds-up in stop chamber 602 which is positioned at the bottom of cylinder 101 where water and ice may accumulate;
Ice may build up in keyway 127 so that the key cannot be fully inserted; and
Ice may build up at the bottom of dust cover 119 and so that the dust cover will not open.

In some cases, customers may bend the dust cover 119 when ice builds up at the bottom of dust cover 119 and the cover won't open when force is applied with a key. A customer faced with ice build-up may firmly push on key 111 with sufficient force to bend the door near the lower pivot point. Deformation of the dust cover may prevent the dust cover from subsequently operating correctly and it may become necessary to replace the prior art pin lock.

Prior art locks may also be prone to corrosion or other water/ice related damage because of water penetration and accumulation within those locks.

There is a need for a suitable mechanical pin lock with weather resistant features for use in outdoor applications.

### SUMMARY

The invention includes an improved, weather resistant pin lock. Various embodiments and aspects of the invention will be apparent to persons skilled in the art, upon reading the entirety of this specification, including the description, drawings and claims appended hereto. The following introduction is meant to provide an overview of the invention, without limiting the invention to the specific aspects and features which are described in general terms for illustration of some examples of the invention.

In one embodiment, a pin lock extends along a longitudinal axis from an outer face at a proximate end to a distal end. The pin lock includes a shell extending between the proximate and distal ends. The shell houses a rotatable core. The core rotates within an interior chamber defined by the shell. The shell also defines an elevated pinway extending along the longitudinal axis. The elevated pinway extends upwardly to a top wall from an intermediate edge defined by the shell. The elevated pinway is bounded by first and second opposed vertical side walls and a vertical end wall extending between the first and second opposed side walls. The end wall is adjacent the distal end of the pin lock. The rotatable core defines a first linear plurality of pin slots communicating with the keyway when an operating key is inserted into the keyway. The elevated pinway defines a second linear plurality of pin slots in opposing relation to the first plurality of pin slots defined by the rotatable core. A first set of pins is held in the first linear plurality of pin slots abutting in coplanar interfacial alignment with a second set of pins in the second linear plurality of pin slots. When in the key is inserted and the lock is in the first position, the core is allowed to rotate, about the axis, within the shell.

A hood is secured above the elevated pinway. The hood, which may take the form of a top cap, defines a rigid water barrier enclosing the second set of pins in the second linear array of pin slots. In this embodiment, the hood extends downwardly from the top wall to the intermediate edge, and about the vertical side walls and the end wall. Preferably, the hood is secured to the elevated pinway along a band adjacent the intermediate edge.

In some aspects of the invention, a band defined by an interior surface of the hood projects inwardly to secure the hood to the elevated pinway. The band may be formed by crimping a lower edge of the hood for secure engagement along the intermediate edge of the elevated pinway. The hood may also be crimped to form the band at the intermediate edge of the elevated pinway.

In some embodiments, the intermediate edge is adjacent to a bottom edge of the elevated pinway, extending along a shoulder defined by a bottom portion of the shell.

Some aspects of the invention may feature an interior drainway which extends downwardly and outwardly from within the pin lock. The drainway may extend below an access door to the keyway which is pivotably mounted between the outer face and the keyway. The drainway may be provided to channel water outwardly via a drain opening. The drainway may define a pathway for water to flow outwardly from the shell, the rotatable core, the access door, and an outer face ring which covers the face of the shell while surrounding the keyway. The access door may be pivotably mounted on a post extending between a top recess in a frame and a bottom recess in the frame. The bottom of the access door may define an elevated bottom edge which travels above an adjacent surface defined by the frame or a bottom edge of a recess within the face of the rotatable core. The elevated edge may define a clearance gap above the adjacent surface when the access door pivots within the frame. The post may be rotatable relative to the frame and the access door.

A detent may be featured adjacent the intermediate edge, between the interior surface of the hood and an adjacent surface of the elevated pinway to more securely fasten the hood to the elevated pinway. The hood may be crimped, press-fit, snap-fit, slide-fit or the band may be formed in another manner to provide secure engagement with the detent.

By way of further example, the detent may be an elevated ridge or a recess adjacent the intermediate edge.

In another aspect, the pin lock comprises an outer face ring at a proximate end. The pin lock includes a shell defining an elongated body extending along a longitudinal axis between the proximate end and the distal end. The shell houses a rotatable core adapted for connection to a driver, cam or other component of a lock mechanism. The shell defines an elevated pinway extending along the longitudinal axis. The elevated pinway extends upwardly to a top wall from an intermediate edge extending from a pair of opposed shoulders defined by the shell. The elevated pinway comprises: a first vertical side wall, a second vertical side wall opposite to the first vertical side wall, and a vertical end wall extending between the first and second side walls, the end wall being adjacent the distal end. The elevated pinway defines a first set of pins in a first linear plurality of pin slots through the top wall and vertically opposed to a second set of pins in a second linear plurality of pin slots defined by the rotatable core, the first and second linear plurality of pin slots being vertically aligned and communicating with a keyway in the rotatable core when an operating key is inserted into the keyway when the lock is in a first position. An interior drainway extends downwardly and outwardly from within the pin lock. The drainway comprises a channel along the bottom interior of the shell, and a dripway from the keyway in communication with the channel. The dripway extends along an access door to the keyway and along a proximate lower edge of the shell, for water to flow outwardly via a drain opening. The access door rotates about a post pivotably mounted within a frame between the outer face and the keyway when the access door is pushed away from the keyway upon entry of the operating key into the keyway. The access door may be elevated to define a gap upon rotation above a bottom ledge of the frame. A hood defines a rigid water barrier closing the first linear array of pin slots in the top wall. Preferably, the first set of pins are biased inwardly from a top interior surface of the hood toward the rotatable core. The hood may extend downwardly from the top wall to the intermediate edge, and about the first and second vertical side walls and the end wall, and when the hood is engaged with the elevated pinway, a band defined by an interior surface of the hood projects inwardly to secure the hood to the elevated pinway.

In some aspects, the band may project between the hood and the elevated pinway to secure the hood to the pinway. The hood may be glued or otherwise affixed with adhesive, crimped, press-fit, snap-fit, slide fit or assembled in some other manner, into secure engagement between the band and the elevated pinway. The band may be formed by crimping the hood into secure engagement with a detent defined by the elevated pinway.

In some other aspects, the drainway may define a pathway for water to flow outwardly from the interior of the shell, the interior of the rotatable core, the access door, and an outer face ring surrounding the keyway. In some aspects, a water resistant seal is provided at the proximate end between the outer face ring and the shell or at the distal end to inhibit water ingress between the rotatable core and the shell. Preferably, the pin lock includes water resistant seals at the proximate end and the distal end to minimize water ingress.

Other aspects of the invention will become apparent upon a review of the appended drawings and the following detailed description of preferred embodiments of the invention.

### BRIEF DESCRIPTION OF THE DRAWINGS

FIG. 1 is a drawing of an exploded view, in perspective, of the components in a prior art pin lock;

FIG. 2 is a drawing in perspective, showing a core and a shell of the prior art pin lock shown in FIG. 1;

FIG. 3 is a drawing of a perspective view of an enlarged retainer clip provided with the prior art pin lock shown in FIG. 1;

FIG. 4 is a drawing of an exploded view, in perspective, of the components of an embodiment of the present invention, namely, a pin lock;

FIG. 5A is a side view of the rotatable core of the embodiment of the invention shown in FIG. 4;

FIG. 5B is a frontal view of the rotatable core of the embodiment of the invention shown in FIG. 4;

FIG. 5C is a side view in perspective from the distal end of the rotatable core of the embodiment of the invention shown in FIG. 4;

FIG. 6A is a frontal view, in perspective, of the proximate end of the shell housing of the embodiment of the invention shown in FIG. 4 configured for clockwise (CW) rotation of the rotatable core;

FIG. 6B is a frontal view of the shell housing of the embodiment of the invention shown in FIG. 4 configured for clockwise (CW) rotation of the rotatable core;

FIG. 6C is a perspective view, from the distal end, of the shell housing of the embodiment of the invention shown in FIG. 4;

FIG. 6D is a frontal view, in perspective, of the proximate end of the shell housing of the embodiment of the invention shown in FIG. 4 configured for counter clockwise (CCW) rotation of the rotatable core;

FIG. 6E is a frontal view of the shell housing of the embodiment of the invention shown in FIG. 6D configured for counter clockwise (CCW) rotation of the rotatable core;

FIG. 6F is a perspective view, from the distal end, of the shell housing of the embodiment of the invention shown in FIG. 6D; and

FIG. 7 is a profile view of the distal end of the prior art shell shown in FIGS. 1 and 2.

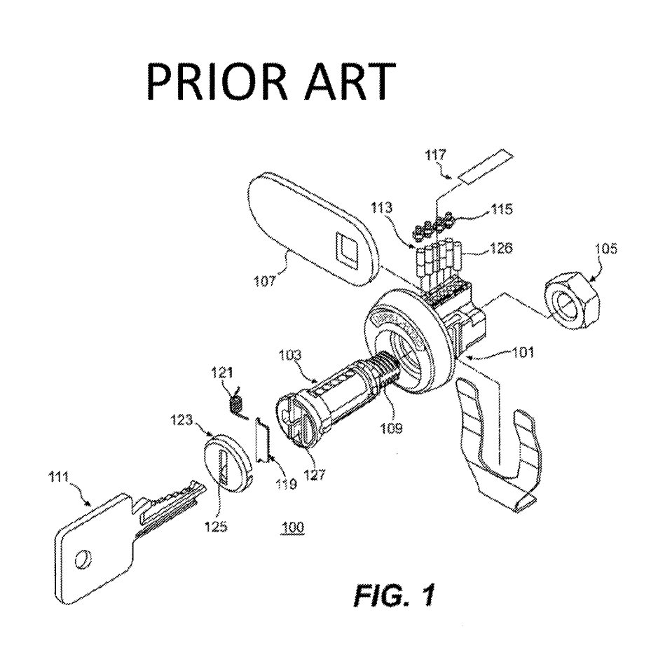

### DETAILED DESCRIPTION

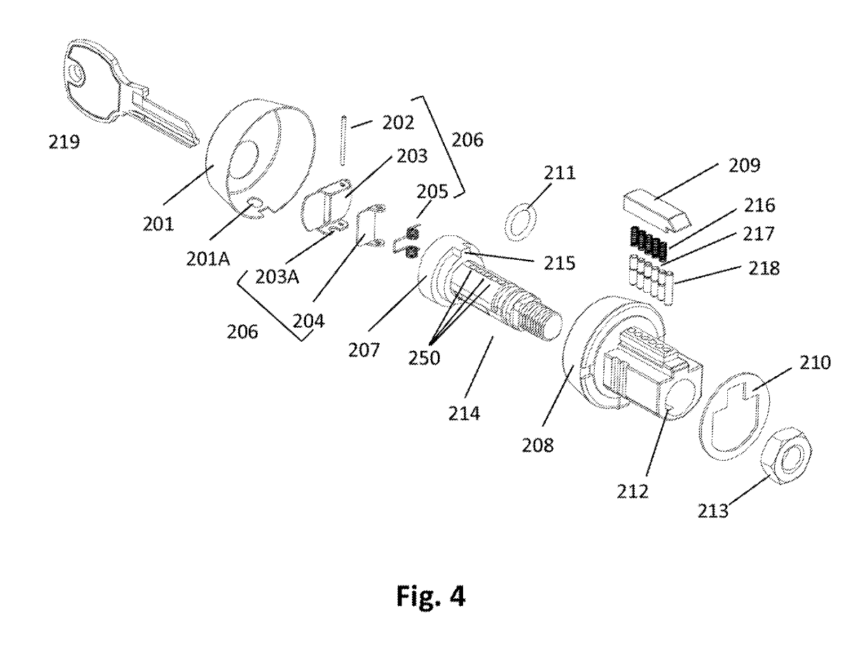

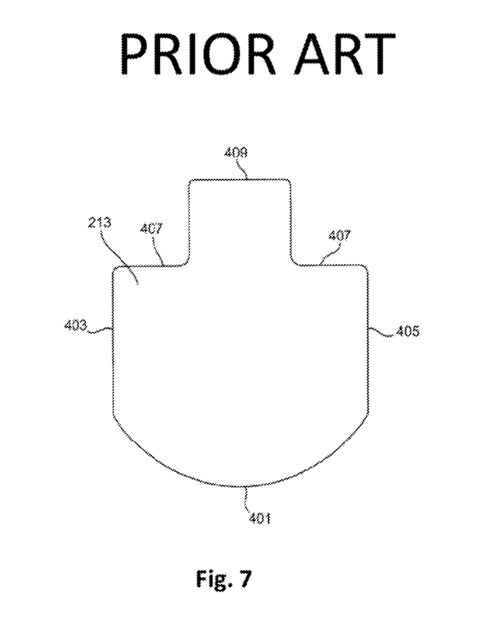

A preferred embodiment of the invention is described below having regard to the preferred embodiment as illustrated in FIGS. 4, 5A-5C, and 6A-6C. For applications in which the pin lock of the present invention will be used in retrofit installations, the shell assembly will be configured to match the existing furniture cut-out representing the available space for installation of the replacement lock. In this example, the profile of cylinder 101 is shown as 213 in FIG. 7. It is preferred that the shape of cylinder 101 is designed to match the existing profile in the furniture so that the lock can be retrofitted into existing furniture, for example, a storage structure having at least one locking compartment.

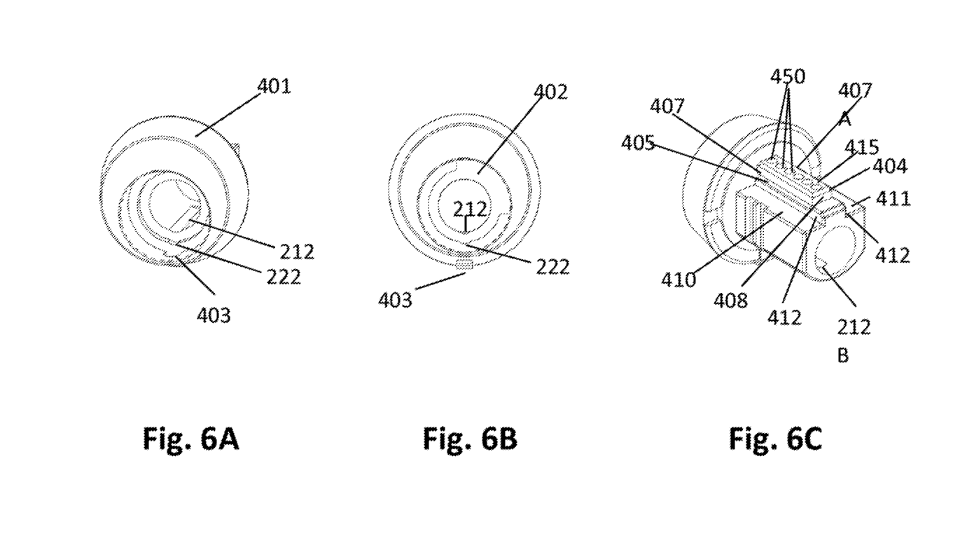

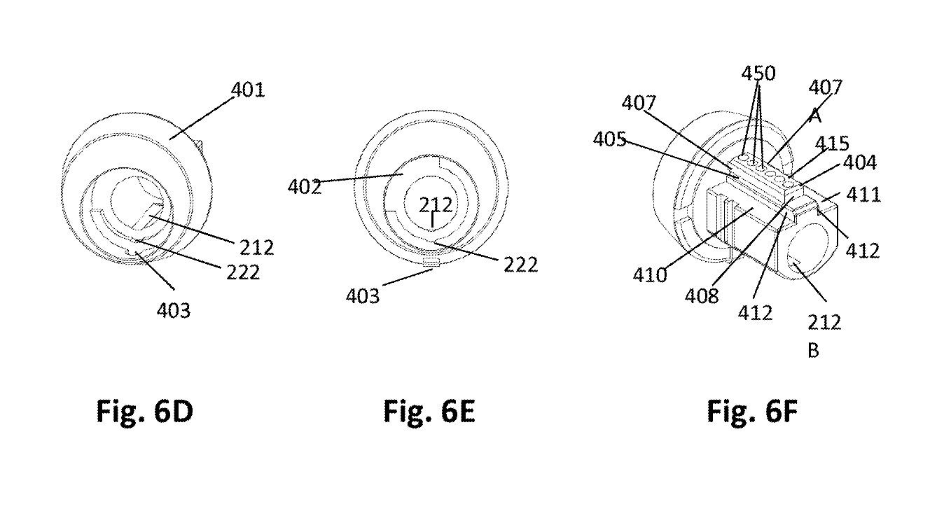

With reference to FIGS. 4 and 6C, the preferred pin lock of the present invention includes a shell configured as a generally U-shaped cylinder 208 which defines a chamber housing rotatable core 207, preferably made from stainless steel. The shell head 401 of the shell 208 is configured to securely accommodate protective shell scalp 201. The shell 208 is provided with shoulders 410, 411 extending to intermediate edge 412 which defines the transition between the shoulders 410, 411 and vertical sidewalls 407, 407A and vertical end wall 408 joining the sidewalls 407 and 407A. In this embodiment, the elevated pinway is illustrated as a modified pin chamber area 404 configured to accept snug fitting top cap 209. The top edges of sidewalls 407, 407A and end wall 408 are preferably beveled to permit a hood, for example, the top cap 209, to be more easily placed and properly aligned with the elevated pinway during assembly of the preferred pin lock.

Preferably, the top cap 209 is crimped such that a band of the top cap 209 is formed to engage with groove 405 to securely hold the top cap 209 in place, closing the second linear array of pin slots 450, after the crimping operation. The top cap 209 functions as a pin slot closure and a water resistant hood which inhibits water from entering the pin slots 450 and 250 and freezing the pins 217, retaining pin 218, springs 216 . The top cap 209 will be made from a suitable material, preferably a metal suitable for the manufacturing process, such as crimping, in the preferred embodiment, and to meet other product specifications.

In other embodiments, the top cap 209 may be configured so that the top cap is fastened to an elevated pinway using another manufacturing technique. For example, the top cap may be press-fit, snap-fit, or slide-fit into place so that a preformed band on the top cap engages a detent on the elevated pinway. By way of further example, the detent may be a ridge or a depression formed on the elevated pinway, preferably adjacent the intermediate edge 412. Upon reading this specification, it will be apparent to persons skilled in the art that other techniques and features may be used to secure a hood to an elevated pinway of the present invention.

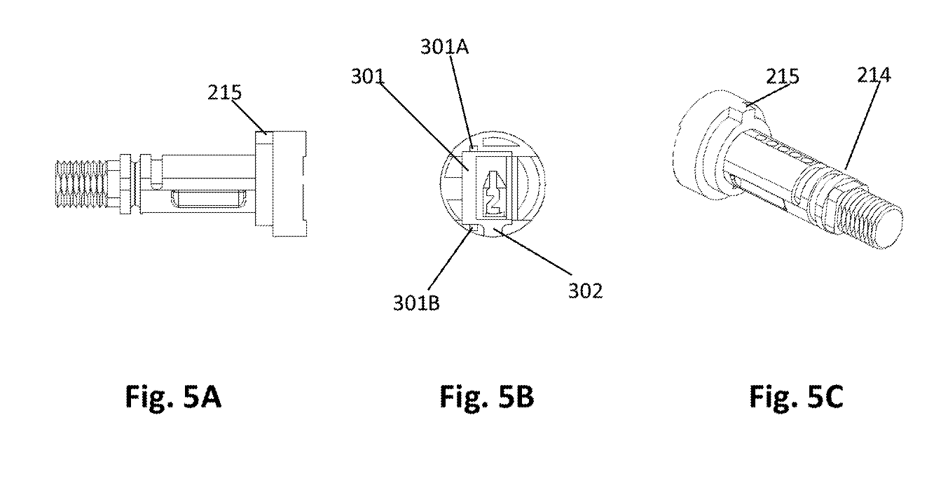

In the preferred embodiment of an assembled pin lock, a drainway is provided to channel water outwardly from the interior of the lock so that the water is removed to avoid, for example, freezing which may damage or render the lock inoperable. In the preferred embodiment as illustrated in FIGS. 5B and 6A-6C, the drainway comprises a drainage channel 212 at the bottom of the shell interior which extends from its distal end 212B, toward the proximate end of the shell 208, over drip edge 222. Drainage channel 212 is configured so that water drains from the distal end 212B forward to drain through drainage holes 403, 203A and 201A.

As shown in FIG. 5B, a lower cavity 302 is also provided in the proximate face of the rotatable core 207 so that water may vacate more easily away from the keyway, and thus preventing ice build-up behind an access door such as the illustrated dust shutter door 204. Preferably, the lower cavity 302 is positioned so that, when the lock is in the locked position, the lower cavity 302 is positioned above drainage hole 403 and shell drainage hole 201A. The funnel-like shape (with inwardly sloped side walls) and position of the lower cavity 302 below the dust shutter door 204 also creates a gap below the lower edge of the shutter door 204 to permit less restrictive rotational movement of the dust shutter door 204 when it is pushed open with a customer's key 219.

The proximate face of the rotatable core 207 is configured to mount and receive the components of the dust shutter assembly 206. The recesses are adequately shaped and dimensioned to allow the opposite ends of dust shutter pin 202 to engage pin pockets 301A, 301B while supporting dust shutter door 204 and torsional spring 205 within the bracket arms of shutter face plate 203.

The torsional spring 205 is preferably configured as a dual arm spring urging the dust shutter door 204 toward its closed position, to block debris from entering the opening to the keyway when the lock is not being operated with a key 219. The dust shutter pin 202 is preferably round to support the preferred, stronger dual arm torsion spring 205 to improve the closing operation of the dust shutter door 204 particularly when the dust shutter door is impeded by dirt, dust, water or ice. The rounded pin 202 should also rotate more easily even when the dust shutter door or the rounded pin is impeded by dirt or ice.

It is also preferable to avoid accumulation of any water near the rotational range interface defined by, for example, stop 215 which travels within a rotational track defined by cavity 402 as illustrated in FIGS. 5A and 6B.

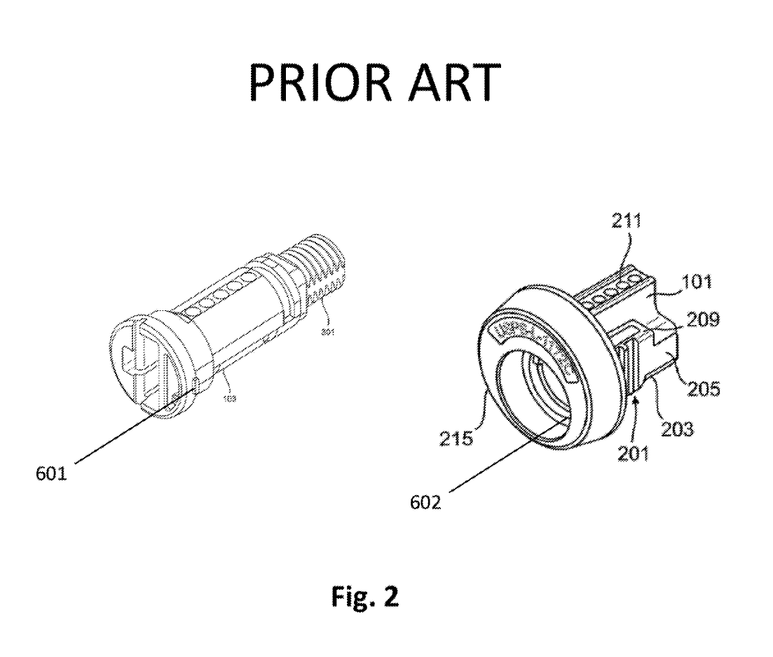

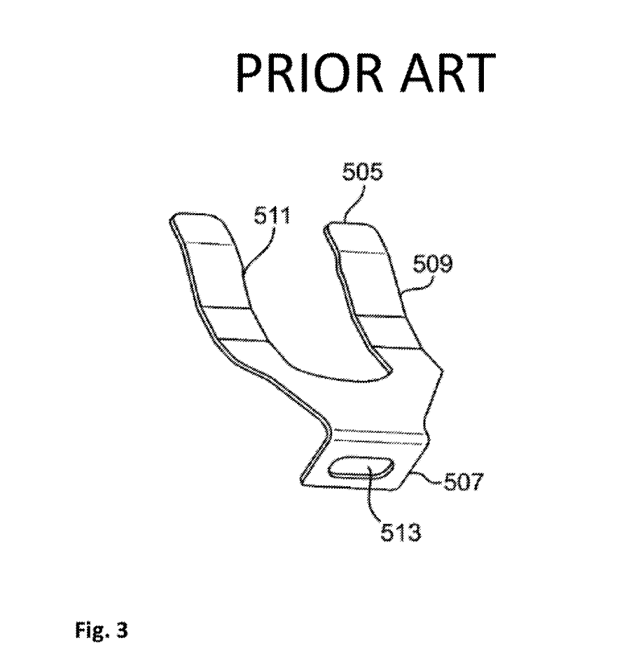

In the prior art pin lock as shown in FIG. 2, stop 601 rotates clockwise from the 3-to-6 o′clock position in stop cavity 602. The stop cavity is near the bottom of cylinder 101. Because of its orientation when the prior art lock is in the locked position, this cavity configuration is prone to buildup of ice adjacent the top of the shell. In a lock of the present invention designed for clockwise (CW) rotation of the core from a locked to an unlocked position, as illustrated in FIGS. 6A, 6B and 6C, the preferred solution is to move the stop 215 to the 12 o′clock position shown in FIGS. 5A, 5C. In the preferred embodiment of the present invention, the stop 215 rotates clockwise (CW) from a position starting at 12 o′clock and rotating to 3 o′clock. Stop cavity 402 is correspondingly placed at the top of the interior of shell 208 so that ice cannot build up along the interior ceiling of shell 208. In another variant of the invention illustrated in FIGS. 6D, 6E and 6F in which the lock is designed for counter clockwise (CCW) rotation of the core from a locked to an unlocked position, the preferred solution is to provide a configuration in which the stop 215 rotates counter clockwise (CCW) from a position starting at 12 o′clock and rotating to 9 o′clock.

In addition to the preferred drainway which may be provided to drain any penetrating water from within the pin lock, it is also preferable to provide water resistant seals to inhibit the inward flow of rain or other water surrounding the pin lock.

For example, the rotatable core may be lengthened to provide additional mounting space shown as O-ring groove 214 to hold a rubber O-ring 211 as a barrier to inhibit water ingress from the distal end between rotatable core 207 and shell 208. For example, the rubber O-ring 211 may be mounted within O-ring groove 214 prior to assembly.

A shell scalp 201 is shown as a rigid protective shroud to be fastened over the proximate face of the shell 208. The shell scalp is configured to hold the dust shutter assembly 206 in place and to inhibit water ingress from the proximate end, which is often exposed to the elements when the lock is used in outdoor installations. A front gasket 210 may also be added adjacent the proximate end of the pin lock, between the pin lock shell and a surrounding wall of a storage structure such as a lock box. The gasket material is preferably selected to satisfy a product specification for outdoor use. These are only two examples of the various kinds or seals which may be provided to inhibit water ingress.

### Preferred Materials Choices

While it will be understood that persons skilled in the art will have reasons to select from a wide variety of construction materials, the following materials are preferred for the present invention.

201 Scalp—preferably stainless steel;

206 Dust Shutter Assembly (202-205)—preferably stainless steel;

207 Core—preferably stainless steel, preferably MIM (Metal Injection Molded) hardened to appropriate manufacturing specifications selected for the product installation(s);

208 Shell—preferably cast from zinc;

Hex Nut 105, Retaining Clip 505 are preferably plated in Zinc Nickel Alloy (automotive grade plating) to reduce rusting; and

Pins 113 and Retaining Pin 126 are preferably made of stainless steel.

Preferably, the lock is treated with lubrication during assembly.

Persons skilled in the art will appreciate that the foregoing description was directed to specific embodiments of the invention. However, many other variations and modifications of the invention are also possible. A preferred embodiment of the invention has been described with regard to the appended drawings. It will be apparent to those skilled in the art that additional embodiments are possible and that such embodiments will also fall within the scope of the appended claims.

### PARTS LIST (OF THE PREFERRED EMBODIMENT DESCRIBED HEREIN)

In which “SS” indicates stainless steel. 201—SS Shell Scalp 201A—Shell Drainage Hole 202—SS Dust Shutter Pin 203—SS Dust Shutter Face Plate 203A—Dust Shutter Drainage Hole 204—SS Dust Shutter Door 205—Dual Arm Torsion Spring 206—Dust Shutter Assembly (Shown as 202-205) 207—SS MIM Core 208—Shell 209—Top Cap 210—Front Gasket 211—Rear O-Ring 212—Shell Drainage Channel 212—distal end of shell drainage channel 213—Hex Nut 214—O-Ring Groove 215—stop 250—first linear array of pin slots 301—dust shutter cavity 301A—pin pocket 301B—pin pocket 302—lower cavity 401—shell head 402—stop cavity 403—drainage hole 404—pin chamber area 405—groove 407, 407A—vertical sidewalls 408—vertical end wall 410,411—shoulders 412—intermediate edge 415—elevated pinway 450—second linear array of pin slots 601—stop 602—stop cavity

We claim:

1. A pin lock extending along a longitudinal axis from an outer face at a proximate end to a distal end, the pin lock comprising:
a shell extending between the proximate and distal ends for housing a rotatable core, the shell defining an elevated pinway extending along the longitudinal axis,
the elevated pinway extending upwardly to a top wall from an intermediate edge defined by the shell, and extending between a first and second opposed vertical side walls and a vertical end wall extending between the first and second opposed side walls, the end wall being adjacent the distal end,
the rotatable core defining a first linear plurality of pin slots communicating with the keyway when an operating key is inserted into the keyway, and the elevated pinway defining a second linear plurality of pin slots in opposing relation to the first plurality of pin slots defined by the rotatable core, a first set of pins in the first linear plurality of pin slots abutting in coplanar interfacial alignment with a second set of pins in the second linear plurality of pin slots, when in the first position, to permit rotation of the core, about the axis, within the shell, and
a hood above the elevated pinway defining a rigid water barrier enclosing the second set of pins in the second linear array of pin slots, the hood extending downwardly from the top wall to the intermediate edge, and about the vertical side walls and the end wall, and the hood is secured to the elevated pinway along a band adjacent the intermediate edge.

2. A pin lock as claimed in claim 1, wherein a band is defined by an interior surface of the hood projecting inwardly to secure the hood to the elevated pinway.

3. A pin lock as claimed in claim 1, wherein the band is formed by crimping a lower edge of the hood for secure engagement along the intermediate edge of the elevated pinway.

4. A pin lock as claimed in claim 1, wherein the hood is crimped to form the band at the intermediate edge of the elevated pinway.

5. In the pin lock claimed in claim 1, the intermediate edge is adjacent a bottom edge of the elevated pinway, along a shoulder defined by a bottom portion of the shell.

6. In the pin lock claimed in claim 1, an interior drainway extends downwardly and outwardly from within the pin lock, below an access door to the keyway pivotably mounted between the outer face and the keyway, to channel water outwardly via a drain opening.

7. In the pin lock claimed in claim 1, the drainway comprises a pathway for waterflow outwardly from the shell, the rotatable core, the access door, and an outer face ring surrounding the keyway.

8. In the pin lock claimed in claim 1, the access door is pivotably mounted on a post extending between a top recess in a frame and a bottom recess in the frame, the bottom of the access door defining an elevated bottom edge above an adjacent surface.

9. In the pin lock claimed in claim 1, the post is rotatable relative to the frame and the access door.

10. In the pin lock claimed in claim 8, the elevated edge defines a clearance gap when the access door pivots above the adjacent surface.

11. The pin lock claimed in claim 1 comprising a detent adjacent the intermediate edge, between the interior surface of the hood and an adjacent surface of the elevated pinway.

12. In the pin lock claimed in claim 1, the hood is secured with adhesive, crimped, press-fit, snap-fit, or slide-fit into secure engagement with the detent.

13. In the pin lock claimed in claim 1, the detent is an elevated ridge or a recess adjacent the intermediate edge.

14. The pin lock claimed in claim 1 comprising a protective annular scalp secured over the proximate end of the shell.

15. A pin lock comprising:
an outer face ring at a proximate end,
a distal end,
a shell defining an elongated body extending along a longitudinal axis between the proximate end and the distal end for housing a rotatable core, the shell defining an elevated pinway extending along the longitudinal axis;
the elevated pinway extending upwardly to a top wall from an intermediate edge extending from a pair of opposed shoulders defined by the shell, the elevated pinway comprising: a first vertical side wall, a second vertical side wall opposite to the first vertical side wall, and a vertical end wall extending between the first and second side walls, the end wall being adjacent the distal end,
the elevated pinway defining a first set of pins in a first linear plurality of pin slots through the top wall and vertically opposed to a second set of pins in a second linear plurality of pin slots defined by the rotatable core, the first and second linear plurality of pin slots being vertically aligned and communicating with a keyway in the rotatable core when an operating key is inserted into the keyway in a first position,
an interior drainway extending downwardly and outwardly from within the pin lock, the drainway comprising a channel along the bottom interior of the shell, and a dripway from the keyway in communication with the channel, the dripway extending along an access door to the keyway and along a proximate lower edge of the shell, for water to flow outwardly via a drain opening,
the access door rotating about a post pivotably mounted within a frame between the outer face and the keyway when the access door is pushed away from the keyway upon entry of the operating key into the keyway, the access door being elevated to define a gap upon rotation above an adjacent surface, and
a hood defining a rigid water barrier closing the first linear array of pin slots in the top wall, the hood extending downwardly from the top wall to the intermediate edge, and about the first and second vertical side walls and the end wall, and when the hood is engaged with the elevated pinway, a band defined by an interior surface of the hood projects inwardly to secure the hood to the elevated pinway.

16. In the pin lock claimed in claim 15, the band projects between the hood and the elevated pinway to secure the hood to the pinway.

17. The pin lock as claimed in claim 15, the hood is secured with adhesive, crimped, press-fit, snap-fit, or slide fit into secure engagement between the band and the elevated pinway.

18. The pin lock as claimed in claim 15, the drainway defines a pathway for waterflow outwardly from the interior of the shell, the interior of the rotatable core, the access door, and an outer face ring surrounding the keyway.

19. The pin lock as claimed in claim 15, the band is formed by crimping the hood into secure engagement with a detent defined by the elevated pinway.

20. In the pin lock as claimed in claim 15, the first set of pins are biased inwardly from a top surface of the hood toward the rotatable core,

21. In the pin lock as claimed in claim 15 comprising a water resistant seal at the proximate end between the outer face ring and the shell or at the distal end to inhibit water ingress between the rotatable core and the shell.

22. A pin lock as claimed in claim 21 comprising the water resistant seals at the proximate end and the distal end.

23. A pin lock as claimed in claim 15 comprising a protective annular scalp secured over the proximate end of the shell.
